(19) United States
(12) Patent Application Publication
(10) Pub. No.: US 2003/0011148 A1
(43) Pub. Date: Jan. 16, 2003

(54) Walking device

(76) Inventors: William H. Bridge JR., Alameda, CA (US); Raymond E. Fraze, Alameda, CA (US)

Correspondence Address: KENNETH J. HOVET, NORDMAN, CORMANY, HAIR & COMPTON, P.O. BOX 9100, OXNARD, CA, 93031-9100, US

(21) Appl. No.: 09/903,032

(22) Filed: Jul. 10, 2001

(51) Int. Cl. B62M 1/00

(52) U.S. Cl. 280/1.181; 280/1.13

(57) ABSTRACT

A walking device in accordance with the present invention includes a axle and two mirror-image stilts. Each stilt includes a transverse socket at its top end, and each end of the axle is rotatably inserted into a respective socket. Each stilt has a rear leg and a forward leg that merge into an upper portion. The upper portion is angularly offset from the rear leg to give each stilt an inverted “y” shape when viewed in side elevation. A respective footrest is attached to each stilt so that the footrests extend inwardly toward each other. An upright grip is fixed to each respective transverse socket. The dual leg structures and forward angular offset of the axle from the footrests, function to provide a walking device which is quickly and easily mastered.

### FIELD OF THE INVENTION

The present invention pertains generally to stilts. More particularly, but not exclusively, walking stilts are disclosed which have a unique methodology and structural arrangement which allows for immediate use and enjoyment by operators of all ages and skill levels.

### BACKGROUND OF THE INVENTION

Stilts are well-known as devices which are used to elevate a user while walking. These walking devices provide an enjoyable pastime for people who possess sufficient skill and coordination. Moreover, some stilts may be an effective implement for accomplishing tasks where an additional amount of height is desired. In such case, the tedium of constantly moving a ladder/stool can be avoided. An example of such an application might be painting the trim of a house.

Skill and coordination are required to operate stilts because the operator must typically stand on footrests on the stilts which are spaced-apart from the ground. This causes a much different perception of the ground and surrounding environment for the operator, and it is this differing perception that makes stilts fun to operate.

While this differing perception of the surrounding environment is what makes stilts enjoyable to use, it is also what creates the need for a minimum level of skill. This is because the operator must remain balanced while on the stilts. It may be difficult, or even impossible, for some people to use stilts, primarily because of the skill and coordination level required to maintain their balance. Moreover, while learning to operate the stilts, the operator may fall repeatedly with the potential of being hurt.

For stilts with non-leisure applications, it is obviously undesirable to provide stilts which take so much skill and concentration to use, that performing any concurrent task is all but impossible. For instance, in the house trim-painting example mentioned above, it is hardly conceivable that one would try to paint house trim with stilts that are currently available in the prior art. Thus, for both work and play, it is desirable to provide a pair of stilts which are easily mastered, stable and yet still provide the same additional height that is provided by prior art stilts.

U.S. Pat. No. 2,965,385, which issued to C. Ayala for an invention entitled “Walking Simulated Toy”, describes an invention wherein two legs are interconnected by a strut and wherein two rear legs are also interconnected by a strut. Additionally, both the forward pair and the rear pair of legs are interconnected by a horizontal crossbar which allows each set of forward and rearward legs to intermittently spring forward and backward.

The above described invention, however, does not include outstanding handles to allow for control of the device. Further, the invention as disclosed in Ayala, includes the aforementioned forward cross-bar structure which allows for sitting on the toy during operation. Finally, the connection between the front feet and the rear feet in Ayala is hinged. This adds to the complexity of the device and makes Ayala's assembly unusable as stilts. In fact, the device of Ayala is designed to be sat upon as a riding toy, and not stood upon as stilts.

In light of the above, it is the object of the present invention to provide a stilt-like walking device whose operation can be quickly and easily mastered. It is another object of the present invention to provide a walking device which provides an increased level of stability for non-leisure applications. Another object of the present invention is to provide a walking device with stilts which are connected to each other with structure which allows for use of the stilts by people of various levels of coordination and physical skill. An additional object of the invention is to provide a walking device which is configured with a minimum of moving parts to allow for simple construction and enhanced durability. Yet another object of the present invention is to provide a walking device which is relatively easy to manufacture, comparatively cost effective and is entertaining to use. A still further object of the invention is to provide a pair of stilts that can be very easily disassembled and stowed in a compact manner.

### SUMMARY OF THE INVENTION

A walking device in accordance with the present invention includes an axle which interconnects two stilts in a spaced-apart relationship. Each stilt consists of a planar framework comprising an upper structure and a lower structure. The upper structure includes an upper portion having a top end from which extends a transverse socket. The lower structure includes a rear leg and a front leg which merge at a junction member. The upper portion is angularly offset from an axis that may be coextensive with a rear midsection of the rear leg. The front leg is fixed to the junction and extends forwardly to give the stilt an inverted “y” shape when viewed in side elevation.

Each transverse socket includes an inwardly directed axle opening. To pivotally mount the stilts to the aforementioned axle, each respective opposing end portion of the axle is inserted into a corresponding axle opening. The transverse sockets are then moved toward each other and over the axle until they abut each other or they a engage a mid-point axle rib or bearing ring. The sockets have sufficient length to space-apart the stilts a distance greater than the width of a person. The distance can be adjusted by varying the width of the rib or ring, by varying the number of rings or by adjusting the socket lengths. When both stilts are connected to the axle, the stilts define vertical planes that are preferably parallel to each other.

A footrest is attached to each stilt proximate the location where the front leg fixedly merges into the upper portion so that the pedals extend inwardly toward each other, and the operator stands on the footrests during operation of the walking device. The angular offset of the upper portions from the rear legs allows the operator to stand on the pedals in a balanced comfortable position during use.

To facilitate operation of the walking device, grip means are provided which may comprise a pair of adjustable hand grips. The grips may be fixedly mounted to each respective transverse socket proximate the top end of the stilts. The grips extend about vertically upward, and the operator uses the grips to maintain balance and assist in moving each leg during operation of the device.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a front exploded isometric view of the walking device of the present invention.

FIG. 1A is an isometric view of an alternative axle that can be used with the invention.

FIG. 2 is a side elevational view of the left stilt, as viewed by an operator, shown in FIG. 1.

FIG. 3 is an isometric front view of the stilts of the device of FIG. 1 during operation.

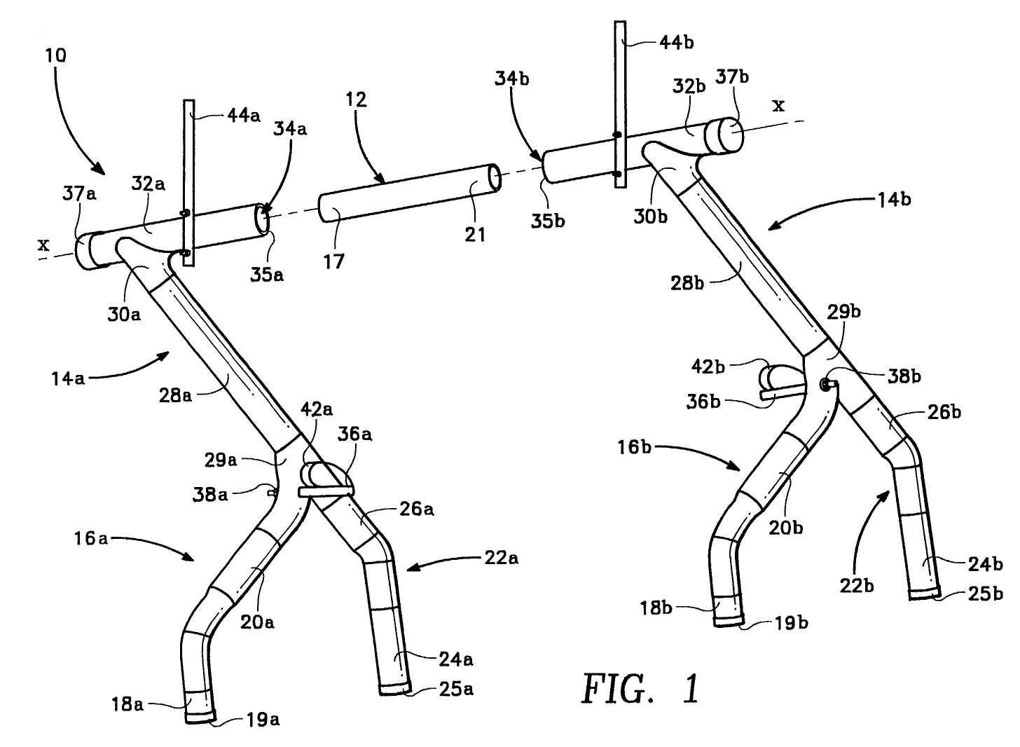

### WRITTEN DESCRIPTION OF THE PREFERRED EMBODIMENT

Referring now to the drawings, the walking device of the present invention is shown and is generally designated by reference character 10. In brief overview, and as shown in the Figures, the device includes an axle 12 which interconnects a right stilt 14a with a left stilt 14b in a manner to be described. Stilts 14a and 14b are mirror images of each other and have the same structure, as also described in further detail below.

Right stilt 14a includes a forward leg 16a with an upright forward lower section 18a that merges into an inclined forward mid-section 20a. Stilt 14a also includes a rear leg 22a comprising an upright rear lower portion 24a that merges into an inclined rear mid-section 26a. Forward mid-section 20a and rear mid-section 26a each merge into a straight upper portion 28a at a connector member shown as junction 29a. Proceeding upwardly from junction 29a, upper portion 28a terminates at a junction part shown as top end 30a.

The longitudinal axes of forward lower section 18a and rear lower section 24a are about parallel to each other. To enhance stability, the forward lower section 18a is located horizontally ahead of top end 30a. The rear lower section 24a is located behind top end 30a. The bottom of each section engages the ground (G) and may include a foot pad 19a, 25a for wear resistance, grip and cushioning purposes.

A transverse socket 32a extends inwardly from top end 30a of the right stilt in a direction about perpendicular to the plane of the stilt. The socket terminates at an abutment rim 35a. The rim defines an axle opening 34a for receiving first end portion 17 of axle 12. Similarly, transverse socket 32b extends inwardly from top end 30b of left stilt 14b in a direction about perpendicular to the plane of the left stilt. The socket terminates at abutment rim 35b which defines axle opening 34b. The opposing outer ends of each socket are preferably closed with respective end caps 37a, 37b.

It is important that each of the transverse sockets extend from respective top ends 30a, 30b in equal and opposite directions. In this way, their respective center longitudinal axes will be co-extensive. It is also preferred that the length and interior diameter of each transverse socket be about equal. Further, the combined length of both sockets should permit a spacing between the stilts that is at least greater than the width of a user's body.

The axle 12 comprises a first end portion 17 and a second end portion 21. The axle should have a length that is at least about equal to the length of one transverse socket. This will permit about one half of the axle to extend into about one half of the length of each transverse socket.

The abutment rims 35a, 35b should comprise smooth bearing surfaces to permit unencumbered relative rotation between the transverse sockets during operation of the stilts. Additionally, the axle should have a diameter that is only slightly less than the inner diameter of each respective socket. The relative diameters should allow free rotation of the sockets about the axle, but the axle engagement should not permit transverse movement, wobbling or unintended separation of the stilts. To further inhibit separation, a detachable strap, sleeve, coupling or fastener could be used to bridge the joint between each socket (not shown).

With the above dimensions and alignments, it is then a simple matter to assemble the stilts by sliding each axle opening 34a, 34b over a respective opposing end portions 17, 21 of axle 12 until abutment rims 35a, 35b are in contact with each other or the aforementioned rib or washer. The walking device is now ready for use.

To encourage an equal engagement of the axle with each socket, an alternative axle 13 may include an annular rib 15 about its midpoint circumference. See FIG. 11a. Alternatively, a washer could be frictionally secured to the axle midpoint.

Each stilt is provided with a respective inwardly extending footrest 36a, 36b. As shown, the footrests comprise rigid rods extending through respective junctions 29a, 29b. The rods are secured with fasteners 38a, 38b (only 38b is shown in the Figures). The rods should have sufficient structural strength to support the weight of a user. Additionally, because they are the primary center of gravity, the footrest location in the lower half portion of each stilt between the forward and rear legs and rearward of the axle joints, creates a easy to use balanced assembly. As shown, footrests 36a, 36b allow the operator 40 to be positioned between stilts 14a, 14b and provide a means for transferring leg movement to the stilts.

To facilitate uplifting each stilt during use, the footrests may have foot straps shown by references 42a, 42b. Alternative footrests could be pedals with overlying foot straps or clip-on pedals common in bicycles.

To further assist in operating the stilts, the device of the present invention also includes a pair of grip means attached proximate the top ends for balance and stilt actuation. As shown, upstanding grips bars 44a, 44b are fixedly mounted to a respective transverse socket 32a, 32b. The grips extend upward from the transverse sockets and provide balancing points for operator 40 during use of the walking device. The grips may also be used to assist in moving the stilts via a pushing and pulling action. For users who are very short or very tall, the length of the grips can be adjusted to provide an optimum configuration. The grips may also comprise enclosed handles, ergonomic finger projections integrated with the top end structure, cushioned pistol grip handles, straps, knobs and levers.

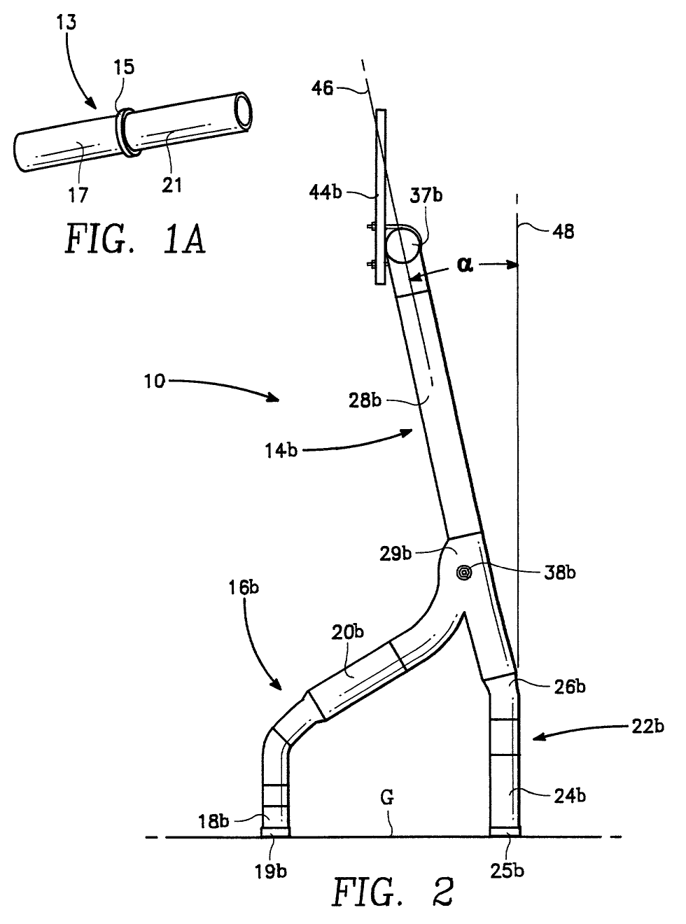

As best seen in FIG. 2, the longitudinal upper axis 46 of upper portion 28b is angularly offset by an acute angle a from the longitudinal rear leg axis 48 of rear lower section 24b. Moreover, the rear leg axis preferably extends vertically. This configuration places the footrest 36b and operator's weight ahead of footpad 25b thereby avoiding an unwanted backward tilt.

The above acute angle also functions to space forward the grips 44a, 44b and axis of rotation x,x of the stilts. This feature provides space for proper arm movement during operation and allows for a user to be in a more upright balanced position. Additionally, by having footpads 19a, 19b ahead of the footrests 36a, 36b, stability is enhanced and unwanted forward tilting of the device is minimized.

In the manufacture of the walking device, stilts 14a, 14b and axle 12 should be made of a material which is light, but which also has relatively high strength-to-weight ratios. The material should also be resilient and durable. Use of hollow tubing with bonded or welded fitments are suitable.

In the preferred embodiment, stilts 14a, 14b are made of a high strength industrial plastic such as high density polyethylene (HDPE) or polyvinvyl chloride (PVC) piping, although materials such as aluminum, wood, ceramics and the like could also be used. The footrests are preferably constructed of metal or metal-rubber combinations. The grips are preferably made of a wood material, although HDPE and PVC plastic and aluminum materials mentioned above could also be used.

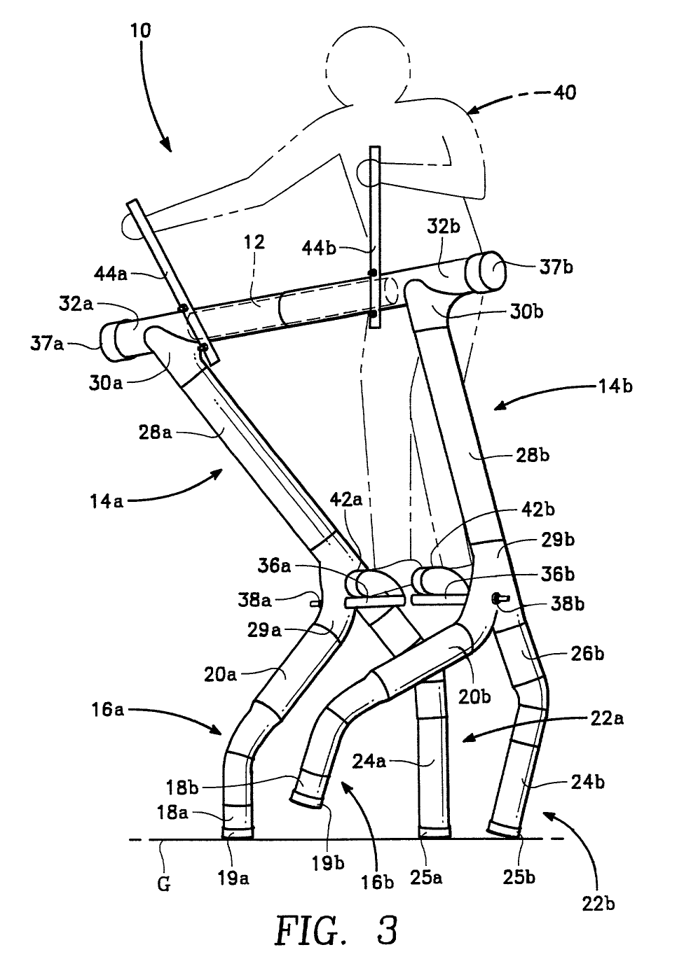

Operation of the walking device of the present invention initially begins with the device at rest, and with forward legs 16a, 16b and rear legs 22a, 22b resting on ground (G). To move left stilt 14b forward, and referring to FIG. 3, operator 40 places a foot on each respective footrest 36a, 36b and then shifts weight toward right stilt 14a. Simultaneously, operator 40 lifts forward leg 16b and rear leg 22b off the ground. With forward leg 16b and rear leg 22b spaced-apart from the ground, the operator pulls back on grip 44b. This causes left stilt 14b to pivot about transverse socket 32b so that forward leg 16b and rear leg 22b move forward.

When rear lower section 24b is about halfway between the original rest position of stilt 14a (i.e. rear leg 22b is about halfway between forward leg 16a and rear leg 22a of stilt 14a), operator 40 lowers stilt 14b. Specifically, left stilt 14b is lowered until rear lower section 24b is just touching the ground. With rear lower section 24b just touching the ground, forward lower section 18b is still spaced-apart from the ground.

Next, operator 40 leans forward, while simultaneously holding grips 44a, 44b to prevent stilts 14a, 14b from pivoting about axle 12, which further causes the tubes to rock forward until the forward lower section 18a is touching the ground. To move right stilt 14a, the above cycle is repeated, but with stilt 14a instead of stilt 14b. With practice, a rhythm and some speed is developed, and the operator's momentum helps rock respective right and left stilts 14a, 14b forward on every step.

While the particular walking device, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. In a walking device wherein the improvement comprises:
a first stilt having an upper structure and a lower structure defining a plane;
a transverse socket extending from said upper structure in a direction about perpendicular from said plane; and,
an axle having a first end portion extending into said transverse socket.

2. The device of claim 1 wherein said upper structure comprises an upper portion extending from said junction to a top end, said transverse socket extending from said top end.

3. The device of claim 1 wherein said lower portion includes a footrest extending transversely to said plane.

4. The device of claim 1 wherein said lower structure comprises a forward leg and a rear leg which are interconnected to said upper structure at a junction.

5. The device of claim 4 wherein said junction is located in said plane above and between said front and rear legs.

6. The device of claim 2 wherein said top end includes a grip means for manually grasping said stilt.

7. The device of claim 4 wherein said rear leg comprises a rear lower section having a rear leg longitudinal axis and said upper portion has an upper longitudinal axis that forms an acute angle with said rear leg longitudinal axis.

8. The device of claim 3 wherein said transverse socket is located forward of said footrest.

9. The device of claim 4 wherein said front and rear legs each comprise a lower section that merges into an inclined mid-section that extends into said junction.

10. The device of claim 1 wherein said axle includes a second end portion; and, a second stilt that is a mirror image of said first stilt having a second transverse socket engaged for rotation with said axle second end portion.

11. A device comprising
at least one stilt having a top end and a bottom end;
said stilt having a rear leg proximate said bottom end and an upper portion fixedly attached to said rear leg so that said upper portion is angularly offset from said rear leg;
a socket transversely mounted to said top end; and,
an axle inserted into said socket to allow for rotation of said stilt around said axle.

12. The device of claim 11 further comprising a forward leg fixedly attached to said upper portion.

13. The device of claim 11 wherein said axle has a first end and a second end and wherein said first end is inserted into one of said sockets and wherein said second end is inserted into another of said sockets.

14. The device of claim 12 further comprising a footrest attached to said forward leg to extend therefrom in the same direction as said axle.

15. The device of claim 14 further comprising a grip handle fixedly attached to said socket to extend therefrom in the same direction as said upper portion.

16. The device of claim 11 wherein rear leg defines an axis and further wherein said upper portion establishes and angle a with said axis.

17. A method for walking with a pair of stilts, said stilts each having a top end and a bottom end and a rear leg and an upper portion fixedly attached to said rear leg so that said upper portion is angularly offset from said rear leg, each of said stilts further having a forward leg fixedly attached to said upper portion and a footrest attached to said forward leg to extend therefrom, said stilts being interconnected by an axle rotatably attached to said respective top end, said method which comprises the steps of:
(A) standing on said footrests;
(B) shifting weight to one of said stilts;
(C) lifting the other of said stilts from the ground;
(D) lowering the stilt of step (C) until said rear leg engages the ground while said forward leg is spaced-apart from said ground;
(E) moving weight forward; and,
(F) lowering said forward leg to the ground.

18. The method of claim 17 further comprising the step of:
(G) rotating said other stilt after step (C).

19. The method of claim 18 where each stilt has a grip means proximate said top end and further comprising the step of:
(H) holding said grip means during steps (B) through (F).
